(19) United States
(12) Patent Application Publication
(10) Pub. No.: US 2014/0168845 A1
(43) Pub. Date: Jun. 19, 2014

(54) Device for thermal monitoring of the terminals of an electrical connection device

(71) Applicant: Cyril Charles, Cars (FR)

(72) Inventor: Cyril Charles, Cars (FR)

(21) Appl. No.: 14/237,924

(22) PCT Filed: Aug. 10, 2012
(86) PCT No.: PCT/FR2012/051882

§ 371 Date: Feb. 10, 2014

(30) Foreign Application Priority Data
Aug. 18, 2011 (FR) 1157406

(51) Int. Cl. H02H 5/04

(52) U.S. Cl. CPC H02H 5/047
USPC 361/104; 361/103

(57) ABSTRACT

The subject matter of the invention is a device for thermal monitoring of a connection device, said connection device comprising at least two terminals to be monitored, including at least one active terminal, the device comprising at least one electrically conductive fault-initiating element electrically connected to a protective conductor, and electrically insulating detection means for detecting abnormal heating, in thermal contact with each terminal to be monitored, the detection means preventing each fault-initiating element from coming into electrical contact with an active terminal so long as these detection means are not subject to a threshold temperature, and the detection means releasing the fault-initiating element when they are subject to a temperature higher than or equal to the threshold temperature in such a way that this fault-initiating element comes into electrical contact with an active terminal, the thermal monitoring device being characterized in that each fault-initiating element comprises a fixed part and a part that can be moved between a “no fault” position, in which it is held at a distance from an active terminal by the detection means, and a “fault” position in which it is released by the detection means and comes into electrical contact with an active terminal.

This application claims priority based on PCT/FR2012/051882 filed Aug. 18, 2011

### FIELD OF THE INVENTION

The present invention relates generally to electrical devices but more specifically to the thermal monitoring of the terminals of an electrical connection device.

### BACKGROUND OF THE INVENTION

There are many connection devices permit connecting the leads permanently together, in an electrical installation or in an electric appliance. Connection devices moat visible used to connect the leads of the installation with connection devices such as plugs or cable outlets, switches, light sockets, 10 etc.

There are also different types of connecting devices in electrical equipment such as extension cords or power strips, and more generally in all appliances and industrial devices.

Whatever their use, these connecting devices are subject to consistent standards both in terms of their quality and for their implementation. However, the abnormal temperature rise of these connecting devices often occurs over time.

These abnormal overheating originate from the gradual increase in electrical resistance connections that can oppose the passage of current, promoting the aging of the device connection.

In effect, as soon as it is implemented, a connection device has a total resistance equal to the sum of several sub-resistances. Thus, the first sub-resistances are due to the resistivity of the conductors and the material used for the realization of the connection device. Other sub-resistances low of the constriction of the electric lines, oxidation, and the surface quality of the contact area for the passage of electrons, the quality of this zone being also linked to the effectiveness over time of mechanical methods of the electrical contact and the temperature of the connection due to expansion.

Now, these sub-resistances are interconnected, and the increase of one of these sub-resistances has the effect of increasing a chain reaction to the other sub-resistances and therefore the overall resistance of the connections.

For example, slight oxidation of copper (bare and exposed at the connection) will cause a decrease in the quality of the contact surface and a modification of the constriction of the electric lines, but also a slight but inevitable Joule effect heating.

This heating promotes the acceleration of oxidation but also the increase in the electrical resistivity of the materials making up the connection and the conductors at the terminal, the electric resistivity of the material increases with temperature.

Thus, for a given electric current in the circuit, the connection undergoes gradual heating increasingly important.

Experts have identified these abnormal heating as the main cause of electrical fires.

In effect, if nothing is provided at the connection to detect this temperature increase, it will increase exponentially. During these phenomena where the temperature of the connection can reach hundreds of degrees, it will create deal conditions for igniting a fire by way of the gradual transfer of heat wound the connection, by the melting insulation releasing gas, by the carbonization of the insulation, etc.

Once the ideal conditions for igniting a fire are in place, heating alone, a spark, or an arc can cause ignition if a fuel material and a combustive are present, which usually ends up being the case because the environment is deteriorating.

The risk of fire is much more widespread that this can occur even at a connection of a circuit with low electric power.

Connections and connection devices therefore have inherently dangerous overheating risks. And objectively, these risks are increased by many other factors.

Firstly, a primary risk factor is related to the number of connections since we make hundreds of connections to make, for example, an electrical system for a house.

Human factor is also important: A small error in the implementation or modification of the installation will ultimately lead to premature aging of the connector and fire.

Moreover, connecting devices lying scattered in the most intricate spaces of buildings can create the ideal conditions for igniting a fire.

Connecting devices also suffer from all kinds of stress that may increase the risk of heat: Surges, electromagnetic forces, vibrations, possible traction forces if the fasteners are inadequate.

Finally, for many connecting devices scattered in buildings, the verification of connections is impractical.

Currently, surge protection devices, such as fuses or circuit breakers provided in the distribution panel of an electrical installation allow detection of a global temperature rise of a circuit and de-energize the circuit concerned.

Similarly, certain electrical devices are equipped with a fuse to detect a global temperature rise of the internal circuitry of the device and turn off the circuit concerned.

Moreover, with a suitable sensitivity of differential protection devices placed in the distribution panel upstream of an electrical installation with the main circuit breaker, detect and control insulation faults, also called parallel arcs in North America, which may occur in electrical circuits or devices that are connected.

However, the known protection devices do not physically detect abnormal hotspot heating of electrical connection that may create the ideal conditions for igniting a fire.

According to a prior art solution to monitor abnormal heating of an electrical connection, periodic inspections are carried out with infrared cameras to identify potential hotpots in electrical installation and prevent the ideal conditions for igniting a fire.

However, in an electrical installation, even in private house, hundreds of connections are made and disseminated throughout the building.

Also, such a periodic inspection is long to implement or unfeasible in certain cases.

A second solution disclosed in FR-2,803,122, proposes a device used to physically monitor the abnormal heating of a terminal of an electrical connection wherein the thermal monitoring device comprises a first connecting element in thermal and electrical relation with a terminal of an electrical connection to be monitored. A second connecting element in electrical and thermal link with a protection conductor, for example connected to the Ground of the installation, and methods or electrical connection between them, which combine the first and second connecting elements. These electrical connection methods being able to occupy two states: A first state or normal operating state in which they are thermal insulation, and a second state, or condition of rupture, in which they become electrically conductive when they reach a critical temperature.

Thus, this thermal monitoring device allows for the transmission of a fault current to the protective conductor when the terminal monitored reaches the critical temperature, thus causing the sensing current default protection devices upstream of the installation and therefore the switching off the power supply to the circuit concerned.

Fault current in the protective conductor, or the Ground, being the first phenomenon wherein electrical installations are protected, such a thermal monitoring device is entirely appropriate to prevent hotspots conducive to igniting a fire.

However, the device disclosed in FR-2,803,122 does not allow to simultaneously monitor a plurality of electric connection terminals, including terminals and a connection device comprising an active terminal, a terminal and a Neutral terminal protection.

### SUMMARY OF THE INVENTION

In view of the foregoing disadvantages inherent in the known devices now present in the prior art, the present invention, which will be described subsequently in greater detail, is to provide objects and advantages which are:

To provide for a device that performs thermal monitoring of at least two terminals of an electrical connection device simultaneously while respecting the electrical stress regarding the electrical installation and the use of electrical circuits connected by the controlled connections.

It is another advantage of this invention to provide a means prohibit short-circuiting of the monitored terminals by one or more fault trigger elements, and limits or modulates the fault current value sent to the protective conductor.

In order to do so, the invention comprises a thermal monitoring device with a device for electrical connection of an electrical installation, the connection device comprising at least two terminals to be monitored, including at least one active terminal, connecting a first electrical circuit to a second electrical circuit, the device comprising of at least one element to create a fault with the electrical conductor and with a protective conductor of the electrical system, and the detecting methods for abnormal heating of electrical insulation and in thermal contact with each terminal to be monitored, the detection methods to prevent each fault trigger element by making electrical contact with a monitored terminal as these methods of detection are not subject to a threshold temperature, and detection methods releasing trigger element when subjected to a temperature greater then or equal to the threshold temperature so that the trigger element creates a Ground fault of the electrical contact with a terminal to be monitored.

Preferably, to improve the detection by creating an electric fault, this invention provides that the fault trigger element comes into electrical contact with an active terminal, that is to say carrying an electric current, from the electrical connection device regardless of which terminal is abnormally heated.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a pert of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 An electrical connection for connecting a first electrical circuit to a second electrical circuit.

FIGS. 2a-b The operation of a first variant of a first mode of the detection methods of the thermal control in a first mode of realization according to the invention.

FIG. 3 A second variant of a first mode of the detection methods of the thermal control in a first mode of realization according to the to invention.

FIG. 4 A second mode of the detection methods of the thermal control in a first mode of realization.

FIG. 5 A first variant of the anti-short-circuit methods of a thermal monitoring device in a second mode of realization.

FIG. 6 Second variant of the anti-short-circuit methods of a thermal monitoring device in a second mode of realization.

FIG. 7 A first variant of the anti-short-circuit methods of a thermal monitoring device in a third mode of realization.

FIG. 8 Second variant of the anti-short-circuit methods of a thermal monitoring device in a third mode of realization.

FIG. 9 Shows a first variant of an external housing of a thermal monitoring device being designed to be connected in parallel to a connection device to be monitored.

FIG. 10 An electrical connection, such an electrical outlet, fitted with a first variant of an external housing of a thermal monitoring device being connected in parallel to the connection device to be monitored.

FIG. 11 Second variant of an external housing of a thermal monitoring device being designed to be connected in parallel to a connecting device to be monitored.

FIG. 12 Third variant of an external housing, adapted to a connection to an electrical connection terminal, a housing of a thermal monitoring device being designed to be connected in parallel to the connecting device to be monitored.

### DETAILED DESCRIPTION OF THE PREFERRED EMBODIMENT

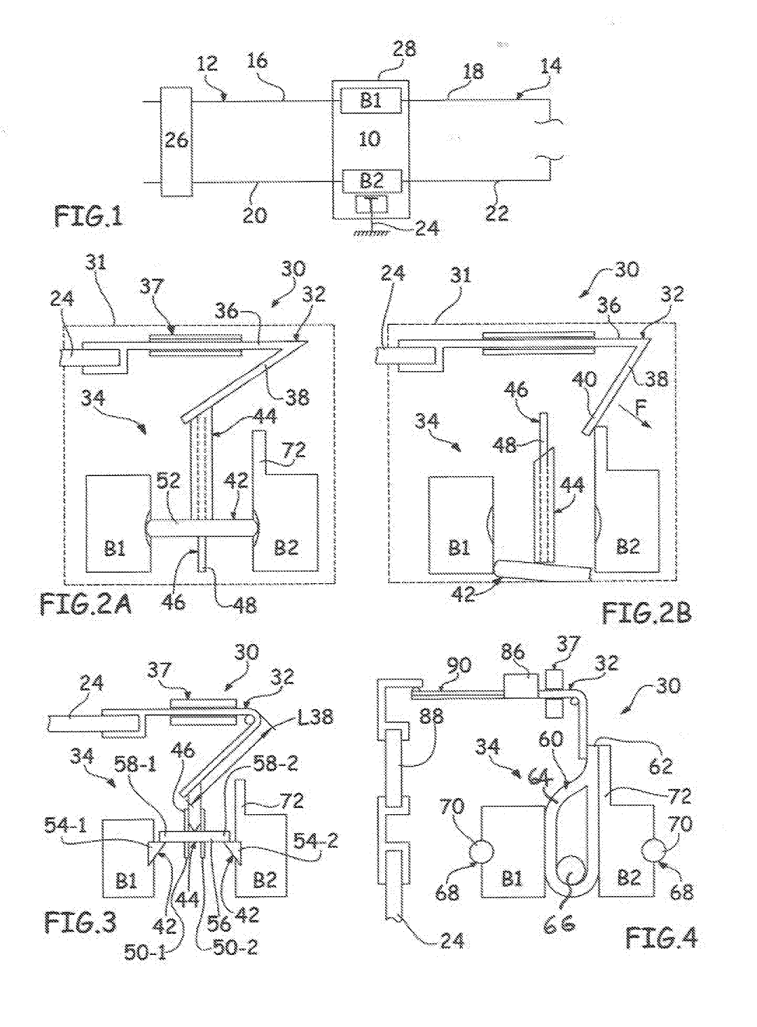

A thermal monitoring device according to the invention is intended to equip an electrical connection device 10 as shown in FIG. 1 and connecting a first electrical circuit 12 to a second electrical circuit 14.

For example, the first circuit 12 may be a circuit of an electrical distribution system and the second circuit 14 may be the internal circuit of an electrical appliance powered by the distribution circuit.

To connect the first circuit 12 to second circuit 14, the electrical connection device 10 comprises at least two monitor terminals: a first terminal B1 for connecting a first conductor 16 of the first circuit 12 to a first conductor 18 of the second circuit 14, and a second terminal B2 allows for connecting a second conductor 20 of the first circuit 12 to a second conductor 22 of the second circuit 14.

According to the single-phase, two-phase or three-phase electrical installation, the electrical connection device 10 may monitor: one, two, or three active terminals, and often a neutral terminal.

By active terminal, the invention means a terminal having a non-zero potential, for example connected to a phase conductor carrying an electric current. And, by neutral terminal, the invention means a terminal having a substantially zero potential, for example connected to a neutral conductor constituting the reference potential of the installation.

Also, the present invention aims to allow for thermal monitoring of electrical connection comprising of two, three, or four terminals to be monitored; hence one, two, or three active terminals.

In accordance with the standards in force in most countries, the electrical connection device 10 also includes a terminal T, this terminal T being connected to a protective conductor 24 to channels leaking current to a conductive mass with substantially zero potential, such as Ground.

For example, in the case where the second circuit 14 is the internal circuit of an electrical apparatus, the protection terminal T allows to connect metal masses of the device to Ground.

Thus, when the protection terminal T is associated with a protection device 26 against insulation faults provided upstream of the installation, the fault current discharged by the protective conductor 24 is detected by the protection device 26 which triggers or de energizes the circuit.

The protective device 26 may take the form of a differential device or Interrupter (RCI), a circuit breaker, a GFCI, or isolation controller, according to the Neutral-to-Ground schematic of the installation.

For its implementation, the thermal monitoring device 30 according to the present invention must be connected to a protective conductor 24, already connected, or not, to the electrical connection device 10 to monitor.

Indeed, the device according to the invention has the general principle of creating an electrical fault in the electrical connection device 10 monitored to transmit a fault current to the protective conductor 24 when abnormal heating is detected. Also, in order to trigger the electrical connection device 10 and monitored circuits (14,16) which it connects when abnormal heating is detected, the thermal monitoring device according to the present invention must be associated with a protection device 26.

This protection device 26 has its own cut-off methods of the power supply, or is connected to a interruption device which can trigger the operation. Thus, upon detection of abnormal heating, the protection device 26 detects the leaking current corresponding to the fault created by the thermal monitoring device 30 and de-energizes the electrical circuits (12, 14) and the electrical connection device 10 to avoid the risk of initiating a fire.

Advantageously, a connector housing 28 constituting the electrical connection device 10, the thermal monitoring device 30 may be integrated to the connector housing 28, or realized in another housing 31 added to the connector housing 28 and interposed between the electrical circuits (12,14) and the electrical connection device 10.

As shown in FIGS. 2A to 8, the thermal monitoring device 30 according to the invention comprises at least one fault trigger electrical conductor 32 and electrical connection with the protective conductor of the electrical system 24, directly or by the protection terminal T of the electrical connection device 10.

Then, the thermal monitoring device 30 also includes methods for detection 34 of an abnormal heating, these methods of detection 34 being electrical insulation and thermal contact with each terminal (B1, B2, B3, B4) to be monitored. These detection methods 34 are not subjected to a threshold temperature corresponding to an abnormal temperature rise, the detection methods 34 prevents each trigger element 32 to make electrical contact with a monitored terminal (B1, B2, B3, B4) and, when the detection methods 34 are subjected to a temperature greater than or equal to the threshold temperature, the detection methods 34 release the trigger 32 so that the trigger element comes into electrical contact with a monitored terminal (B1, B2, B3, B4).

Preferably, in the various modes of the detection methods 34 and to improve the detection by creating an electrical fault, the invention provides that the element creating a fault 32 makes electrical contact with an active terminal (B1, B2, B3, B4) when released by the detection methods (34, 34-1, 34-2).

Coming into contact with an active terminal (B1, B2, B3, B4), the fault trigger element 32 created a leaking current to the protective conductor and therefore a fault detected by the protective device 26 provided upstream of the first electrical circuit 12, then the fault is sanctioned by de-energizing electrical circuits (12,14) and electrical connection device 10.

Still in the various modes of realization of the detection methods 34, each trigger element 32 preferably comprises of a fixed part 36 and mobile part 38. The fixed part 36 is held by fixing methods 37 secured to the connector housing 28 or the housing 31, these fixing methods 37 take the form for example of a piece enclosing the fixed part 36.

The mobile part 38 is mobile between a “no-fault” position, shown in FIG. 2A as well as FIGS. 3 through 8, wherein it is held at a distance from an active terminal (B1, B2, B3, B4) by the detection methods 34 and a “fault” position, illustrated in FIG. 28, in which it is released by the detection methods 34 and comes into electrical contact with an active terminal (B1, B2, B3, B4).

Preferably, in the various modes of the detection methods 34, the mobile part 38 takes the form of an electrically conductive reed spring and tensioned by the detection methods 34 in the “no-fault” position so as to be maintained away from an active terminal (B1, B2, B3, B4).

Preferably, the metal reed spring and is elastically deformed by the detection methods in the “no-fault” position.

Thus, and as shown by arrow F in FIG. 2B, when the detection methods 34 free the extremity 40 of the reed spring, the reed spring tends to retake its initial shape and abuts against an active terminal (B1, B2, B3, B4), which has the effect of creating the desired electric fault.

The detection methods 34 may take various forms. In a first mode illustrated in FIGS. 2A, 2B, 3, and 5 through 8, the detection methods 34 comprise methods 42 fuses placed between at least two active terminals (B1, B2, B3, B4) to be monitored and supporting at least one bigger element 44 preventing a trigger element 32 from making electrical contact with an active terminal (B1, B2, B3, B4) so that these fuse methods 42 are not subjected to the threshold temperature.

Next, and as shown in FIG. 28, when the fuse methods 42 melt under the effect of a temperature greater than or equal to the threshold temperature, the trigger 44 is no longer supported and releases the fault trigger 32.

Advantageously, there may be provided guide methods 46 to avoid that the trigger is interposed between the active terminal and the fault trigger when it is no longer supported by the fuse methods 42.

As illustrated in FIGS. 2A and 28, the guide methods 46 may take the form of a center rail 48 which sides on the trigger 44. Or, as shown in FIGS. 3 and 5, the guide methods 48 are formed by two guide ramps (50-1, 50-2) which circulate within the trigger 44.

In a first variant of the first mode of realization of detecting methods 34 illustrated in FIGS. 2A, 29, and 5-8, each rigger 44 is supported by a fuse strip 52 clamped between two terminals (B1, B2, B3, B4) to be monitored.

In a second variant of this first mode of realization of detecting methods 34 illustrated in FIGS. 3 and 5, each trigger (44, 44-1, 44-2) is supported by a strip (53, 53-1, 53-2) posed on two fuse blocks (54-1, 54-2).

In addition, each wedge (54-1, 54-2) is added, for example, in a suitable housing, on a terminal to be monitored and at the extremity (58-1, 58-2) of each guide strip (53, 53-1, 53-2) rests on a wedge (54-1, 54-2).

In a second mode of realization illustrated in FIG. 4, the detection methods (34) comprise at least one heat-shrinkable element 60 in thermal contact with two terminals (B1, B2, B3, B4) to be monitored, at least a part 62 of each the heat-shrinkable element 60 preventing a fault trigger 32 to come into electrical contact with an active terminal (B1, B2, B3, B4) while this heat-shrinkable element 60 is not subjected to the threshold temperature.

Additionally, this part 62 releases the fault trigger element 32 when heat shrinkable element 60 retracts under the effect of a temperature greater than or equal to the threshold temperature.

Preferably, this heat-shrinkable element 60 is in the form of a loop 84 interposed between two terminals (B1, B2, B3, B4) to be monitored and comprising a projection part 62 forming the retaining/releasing fault trigger element 32.

To ensure that the part 62 releases the fault trigger element 32 when loop 64 is retracted, the loop 64 is maintained at the opposite side where the part 62 is located.

For example, the loop 64 is placed around a fixed pin 66 located opposite to the part 62.

In a first mode shown in FIGS. 2A, 2B, 3, and 4, the thermal monitoring device 30 according to the invention can monitor two terminals: a Neutral terminal B1 and B2 active terminal.

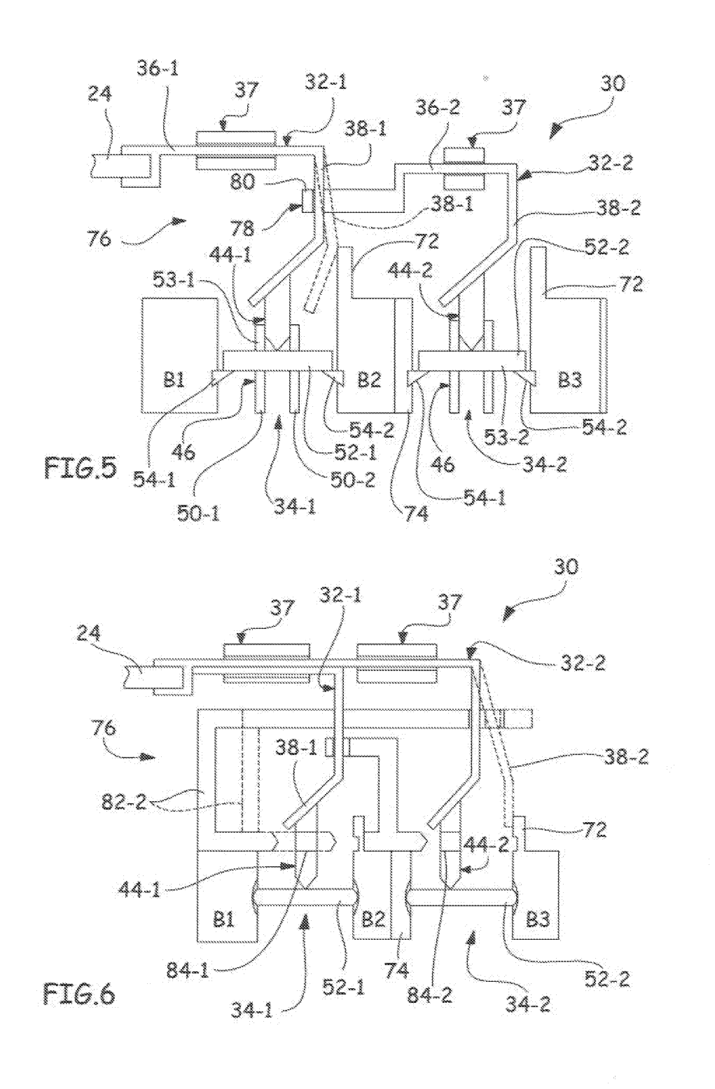

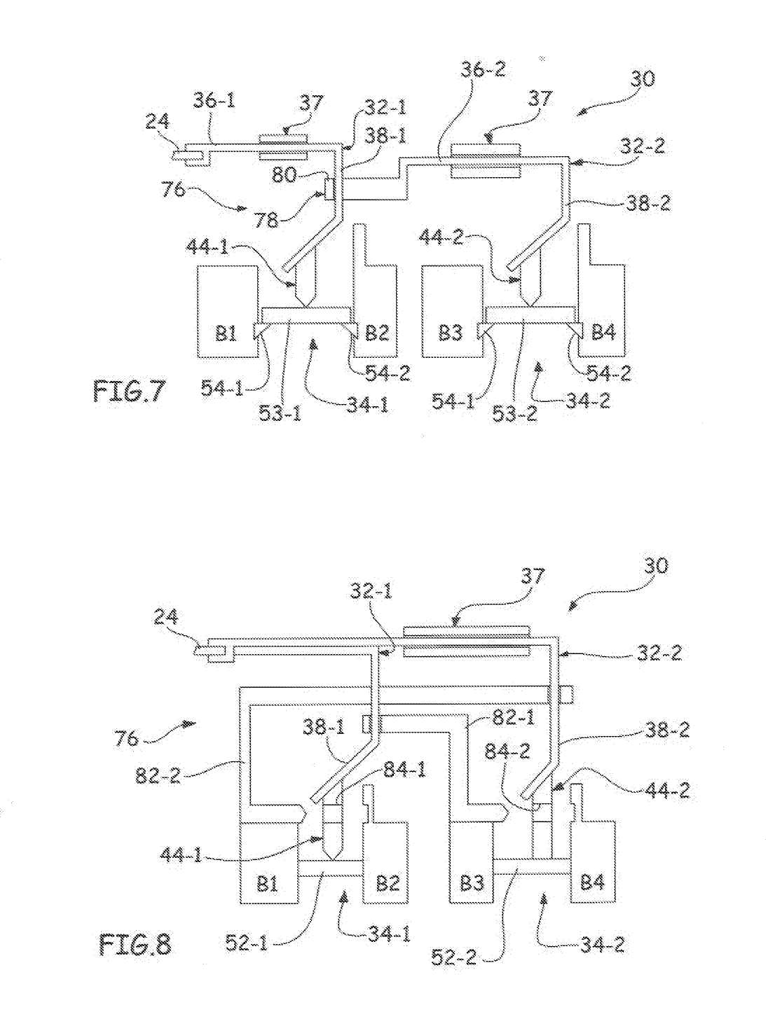

However, in a second mode illustrated by FIGS. 5 and 6, the thermal monitoring device 30 according to the invention allows to monitor three active terminals (B1, B2, B3), and, in a third mode illustrated by FIGS. 7 and 8; the thermal monitoring device 30 according to the invention can monitor four terminals: a Neutral terminal B1 and three active terminals (B2, B3, B4).

Also, in either of these modes of the thermal monitoring device 30, the terminals (B1, B2, B3, B4) shown in the illustrations belonging to the electrical connection device 10 when the monitoring device 30 is integrated. Or, when the device 30 is made in a housing 31 attached to the connector housing 28, the terminals (B1, B2, B3, B4) belong to the device 30 and are connected to terminals of the connector to be monitored by suitable electrical connection methods 68, such as electrical connector 70 as shown in FIGS. 4 and 9.

Still in either of these modes of realization of the thermal monitoring device 30, and regardless if it is integrated or added to the electrical connection device 10, each active terminal (B1, B2, B3, B4) to be in electrical contact with a fault trigger element 32 includes a protrusion 72 extending to the fault trigger element 32.

This protrusion 72 allows the principle of draining current away from the extremity 40 of the mobile part 38 to avoid it from electrical contact with the other terminal to be monitored by the detection methods 34.

In the first mode of realization illustrated in FIGS. 2A, 2B, 3, and 4, the thermal monitoring device 30 allows to monitor two-terminals (B1, B2), the device 30 includes one fault bigger element 32 retained/released by detection methods 34 upon detection of an abnormal heating of the terminals (B1, B2). Of course, in this first mode of realization, the mobile part 38 of the fault trigger element 32, that is, the reed spring is designed so as not to come into contact with the active terminal B2 when released by the detection methods, in order to avoid any risk of short circuit between the two active terminals.

In a second mode of realization shown in FIGS. 5 and 6, for example adapted to monitor the electrical connection device 10 connecting two circuits (12, 14) which is 3 Phase, the thermal monitoring device 30 can monitor three active terminals (B1, B2, B3). For this purpose, the device 30 comprises two fault trigger elements (32-1, 32-2), the first fault trigger element 32-1 being associated fault to first detection methods 34-1 positioned between said first terminal B1 and the second terminal B2, and the second fault trigger element 32-2 being associated with the second detection methods 34-2 placed between the second terminal B2 and the third terminal B3.

To avoid double fault triggering in the event where abnormal heating of the second terminal B2 is detected, a thermal insulation element 74 is interposed between the second detection methods 34-2 and the second terminal B2.

Of course, the invention also covers a variant in which the thermal insulation element 74 is interposed between the first detection methods 34-1 and the second terminal B2.

Preferably, the heat insulation element 74 is joined to the second terminal B2 to minimize the size of the device 30 according to the invention. In this second mode of realization of the thermal monitoring device 30 according to the invention, the first detection methods 34-1 supporting a first trigger 44-1 retaining/releasing the first fault trigger element 32-1 and the second detection methods 34-2 supporting a second trigger 44-2 retaining/releasing the second fault trigger element 32-2, the two elements fault trigger elements (32-1, 32-2) both being electrically connected to the protective conductor 24.

Still in this second mode of the thermal monitoring device 30 according to the invention, each pin (44-1, 44-2) is supported by a guide-strip (53-1, 53-2) resting on two fuse-wedges (54-1, 54-2) or by a fuse-strip (52-1, 52-2), the first guide strip (53-1, 52-1) being wedged between the first terminal B1 and the second terminal B2, and the second guide-strip (53-2, 52-2) being wedged between the third terminal B3 and the thermal insulation element 74 joined to the second terminal element B2.

In a third mode of realization shown in FIGS. 7 and 8, for example adapted to monitor the electrical connection device 10 connecting two circuits (12, 14) of a 3-Phase+Neutral system, the thermal monitoring device 30 can monitor four terminals: a Neutral terminal B1 and three active terminals (B2, B3, B4). For this purpose, the device 30 comprises of two fault trigger elements (32-1, 32-2), the first fault trigger element 32-1 being associated to the first detection methods 34-1 positioned between the first terminal 31 and the second terminal B2, and the second fault trigger element 32-2 being associated with the second detection methods 34-2 placed between the third terminal B3 and the fourth terminal B4.

In this third mode of realization of the thermal monitoring device 30 according to the invention, the first detection methods 34-1 supporting a first trigger 44-1 retaining/releasing of the first fault trigger element 32-1 and the second detection methods 34-2 supporting a second bigger 44-2 retaining/releasing the second fault trigger element 32-2, the two fault trigger elements (32-1, 32-2) both being electrically connected to the protective conductor 24.

Still in this third mode of realization of the thermal monitoring device 30 according to the invention, each pin (44-1, 44-2) is supported by a guide strip (53-1, 53-2) resting on two fuse-wedge (54-1, 54-2) or by a fuse-strip (52-1, 52-2), the first guide-strip (53-1, 52-1) being wedged between the first terminal B1 and the second terminal B2, and the second guide-strip (53-2, 52-2) is wedged between the third B3 and fourth terminal B4 terminal.

In the second and third modes of realization of the thermal monitoring device 30 and to avoid a short circuit between two active terminals by sending a fault current to the protective conductor 24 simultaneously to the first and the second fault trigger elements (32-1, 32-2), the thermal monitoring device 30 according to the invention comprises anti-short-circuit methods 76.

These anti-short-circuit methods 76 prevent the two fault trigger elements (32-1, 32-2) to be simultaneously electrically connected to the protective conductor.

In a first variant illustrated by FIGS. 5 and 7, the methods anti-short-circuit 76 in the form of a mechanical and electrical contacts 78 between the fixed part (36-1, 36-2) of one fault trigger element (32-1, 32-2) and the mobile part (38-1, 38-2) of the other fault trigger element (32-1, 32-2).

In this first variant, one of the fault trigger elements (32-1, 32-2) is connected to the protective conductor 24 by intermediary of the other fault trigger element.

As Illustrated by dotted lines in FIG. 5, the mobile part (38-1, 38-2) opens the mechanical and electrical contact 78 once it is released by the corresponding detection methods (34-1, 34-2).

In the example shown in FIGS. 5 and 7, the fixed part 36-2 of the second fault trigger element 32-2 comprises of a lateral stop 80 against the mobile part 38-1 of the first fault trigger element 32-1 is held by being pressed by the first detection methods 34-1.

Then, when the first detection methods 34-1 release the first fault trigger element 32-1, the mobile part 38-1 thereof moves away from the lateral stop 80 and thus breaks electrical contact between the second fault trigger element 32-2 and protective conductor 24.

In a second variant illustrated in FIGS. 6 and 8, the detection methods (34-1, 34-2) including two triggers (44-1, 44-2) preventing each corresponding fault trigger element (32-1, 32-2) to come into electrical contact with an active terminal (B1, B2, B3, B4), the methods anti-short-circuit 76 comprises two latches (82-1, 82-2), each latch (82-1, 82-2) being combined with a fault trigger (32-1, 32-2).

Thereafter, the anti-short-circuits methods 76 also include openings (84-1, 84-2) through each pin (44-1, 44-2), the latch (82-1, 82-2) combine a first fault trigger element (32-1, 32-2) sliding in the opening (84-1, 84-2) the pin (44-1, 44-2) preventing the second fault trigger element (32-1, 32-2) from coming into electrical contact with an active terminal (B1, B2, B3, B4) when the first fault trigger element (32-1, 32-2) is released by the detection methods (34-1, 34-2).

Precisely, each latch (82-1, 82-2) is connected to the mobile part (38-1, 38-2) of fault trigger element (32-1, 32-2) in a manner to be driven through the opening (84-1, 84-2) the pin (44-1, 44-2) retaining/releasing the other fault trigger element (32-1, 32-2).

In this second variant, because of the Independent operation of each latch (82-1, 82-2), the two fault trigger elements (32-1, 32-2) can be connected directly and permanently to the protective conductor 24.

In the example shown in FIGS. 6 and 8, the first latch 82-1 is connected to the mobile part 38-1 of the first fault trigger element 32-1, and the second latch 82-2 is connected to the part 38-2 of the second mobile fault trigger element 32-2.

As illustrated by dotted lines in FIG. 6, when the mobile part 38-2 of the second fault trigger element 32-2 is released by the second trigger 44-2, the second latch 82-2 is driven through the opening 84-1 of the first trigger 44-1.

Thus, the first trigger 44-1 is blocked and cannot release the mobile part 38-1 of the first fault trigger element 32-1 even if the detection methods 34-1 melt because of an abnormal heating at the first terminal B1 or the second terminal B2. In addition, in any of the modes of realization of the invention and as illustrated in FIG. 4, the thermal monitoring device 30 may comprise of at least one electric resistor component 86 limiting the fault current transmitted by a fault trigger element (32-1, 32-2) to the protective conductor 24. This imitation of the fault current is required to prevent damage of the device 30 when placed in an electric installation in which relatively large intensity (i.e. amperage) of current lows. Of course, the resistor is placed in series between the fault trigger element (32-1, 32-2) and the protective conductor 24.

Advantageously, the thermal monitoring device may also include a fuse 88 connected in series with the electrical resistor 86, or a fuse-resistor between each fault trigger element (32-1, 32-2) and protection conductor (24). This fuse 88, or the fuse-resistor, allows the cutoff of the fault current in the case where the protective device 26 located upstream and does not trigger before a too large supplementary heat is generated by the flow of fault current.

Finally, and also to avoid too much additional heating due to the flow of fault current, the thermal monitoring device 30 may comprise of a bimetal switch 90 connected in series with the electrical resistor 86, the fuse 88 and/or fuse resistor. For its implementation at an electrical connection device 10, the thermal monitoring device 30 can take various forms, examples of which are shown in FIGS. 9 through 12.

As specified above, the temperature monitoring device 30 may be integrated to the connection housing 28 constituting the electrical connection device 10, or it may be added in a housing 31 attached to the connector housing 28 and interposed between one of the electrical circuits (12, 14) and the electrical connecting device 10.

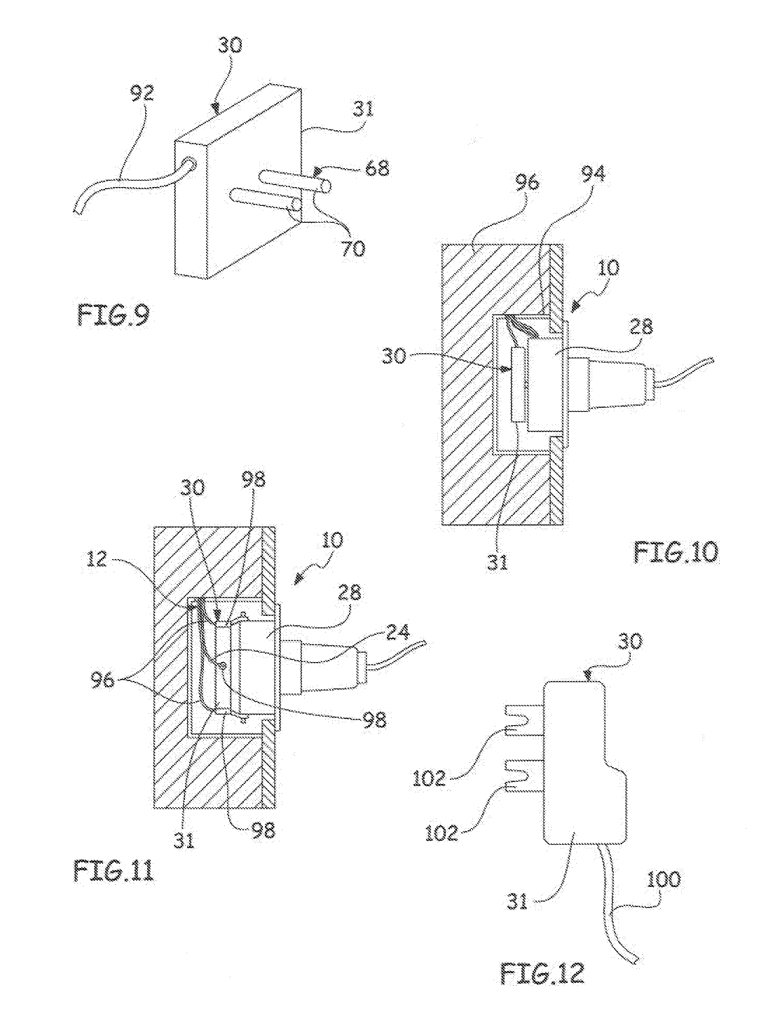

According to a variant of a first outer housing 31 illustrated in FIGS. 9 and 10, the thermal monitoring device 30 is arranged in the housing 31 with external connectors 70 intended to be in contact with the terminals (B1, B2, B3, B4) of the electrical connection device 10 to be monitored, another external connector 92 is provided for connecting device 30 to the protective conductor 24 of the installation.

As illustrated in FIG. 10, the thermal monitoring device 30 is connected in parallel to an electrical outlet to be monitored, the housing 31 being added to the rear of the connector housing 28, for example inside the space 94 realized in a wall 96 for receiving the electrical connection device 10.

In a variant of the second outer housing 31 illustrated in FIG. 11, the housing 31 is interposed in parallel to the wires 96 of the first circuit 12.

For this purpose, the housing 31 includes external junction elements 98 in which the wires 96, are inserted to at least one element 98 is reserved for the connection of the protective connector 24.

In both variants of housing 31, the device 30 is protected and easily integrated in a permanent manner to the installation, and without being visible.

In a third external variant illustrated in FIG. 12 and adapted to a parallel connection of a terminal type electrical connection device main breaker, or with a motor terminal block for example, the housing 31 comprises of external connectors 102 to be plugged into a terminal, another external connector 100 is provided to connect the device 30 to the protective conductor 24 of the installation.

The present invention also includes the electrical connection device 10 equipped with a thermal monitoring device 30, integrated or added in a housing 31, in one of the modes previously described.

Finally, the invention also encompasses variants of thermal monitoring device can be imagined from the various modes described and adapted to monitor electrical connection devices with more than four terminals to monitor.

As to a further discussion of the manner of usage and operation of the present invention, the same should be apparent from the above description. Accordingly, no further discussion relating to the manner of usage and operation will be provided.

With reaped to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A thermal monitoring device of an electrical connection device of an electrical installation, the connection device comprising at least two terminals to be monitored, at least an active terminal, for connecting a first electrical circuit to a second electrical circuit, the device comprising of at least one fault trigger element electrical conductor and electrically connected to a protective conductor of the electrical installation, and detecting methods of an abnormal heating, electrical insulations and in thermal contact with each terminal to be monitored, the detection methods preventing each default setting element to make electrical contact with an active terminal so that these detection methods are not subjected to a temperature threshold, and detecting methods releasing the fault trigger element when subjected to a temperature greater than or equal to the threshold temperature so that the fault trigger element comes into electrical contact with an active terminal, the thermal monitoring device being characterized in that each fault trigger element comprises of a fixed part and a mobile part between a “no-fault” position, in which it is held at a distance from an active terminal by the detection methods, and a “fault” position in which it is released by the detection methods and comes into electrical contact with an active terminal.

2. The thermal monitoring device according to claim 1, characterized in that the mobile part takes the form of an electrically conductive reed spring and tensioned by the detection methods in the “no-fault” position so as to be kept at a distance from an active terminal.

3. The thermal monitoring device according to claim 1 or 2, characterized in that the detection methods comprise of at least one heat-shrinkable element in thermal contact with two terminals to be monitored, at least a part of each heat-shrinkable element hinders a fault trigger element to make electrical contact with an active terminal as long as this heat-shrinkable element is not subjected to the threshold temperature, and this part releasing the fault trigger element when the heat-shrinkable element retracts under the effect of a temperature greater than or equal to the threshold temperature.

4. The thermal monitoring device according to claim 1 or 2, characterized in that the detection methods comprises of fuse
methods positioned between at least two terminals to be monitored and supporting at least one trigger hindering the fault trigger element from making electrical contact with an active terminal as long as that the fuse methods are not subject to the threshold temperature, this trigger is no longer supported and releases the fault trigger element when the fuse methods melt under the effect of a temperature greater than or equal to the threshold temperature.

5. The thermal monitoring device according to claim 4, characterized in that each pin is supported by a fuse-strip wedged between two terminals to be monitored.

6. The thermal monitoring device of claim 4, characterized in that each pin is supported by a guide-strip wedged between two terminals, each wedge being attached to a terminal to be monitored and the extremity of each guide-strip resting on a wedge.

7. The thermal monitoring device according to one of the claims 1 through 6, the electrical connection device comprising of at least three
active terminals, and the monitoring device comprising of at least two fault trigger elements in electrical connection with the protective conductor, characterized in that it comprises of anti-short circuit methods to avoid that the two fault trigger elements are simultaneously electrically connected to the protective conductor.

8. The thermal monitoring device according to claim 7, characterized in that the anti-short-circuit methods take the form of a mechanical and electrical contact between the fixed part a fault trigger element and the mobile part of the other fault trigger element, the mobile part mechanically and electrically opening the contact when it is released by the corresponding detection methods.

9. The thermal monitoring device according to claim 7, the detection methods including two pins each preventing the corresponding fault trigger element from coming into electrical contact with an active terminal, characterized in that the anti short circuit methods comprises of two latches, each latch being integral with a fault trigger element, and
openings through each pin, the latch integral with a first fault trigger element sliding in the opening of the pin preventing the second fault trigger element from coming into electrical contact with an active terminal when the first fault trigger element is released by the detection methods.

10. The thermal monitoring device according to one of claims 1 to 9, characterized in that it comprises of an electrical resistor limiting the fault current transmitted by a fault trigger element to the protective conductor.

11. The thermal monitoring device according to claim 10, characterized in that it includes a safety fuse connected in series with the electrical resistor or a fuse resistor, between each fault trigger element and the protective conductor.

12. The thermal monitoring device according to claim 10 or 11, characterized in that a bi-metal switch is mounted in series with the electrical resistor, the fuse, and/or the fuse resistor.

13. Electrical connection device comprising of at least two terminals to be monitored allow for connecting a first electrical circuit to a second electrical circuit, the electrical connection device being equipped with a thermal monitoring device according to one of the preceding claims, integrated in the electrical connection device or added in a housing.
